(19) United States
(12) Patent Application Publication
(10) Pub. No.: US 2026/0323549 A1
(43) Pub. Date: Oct. 15, 2026

(54) System and Method for Round Trip Time Measurement in a Telecommunication Network

(71) Applicant: Northeastern University, Boston, MA (US)

(72) Inventors: Rajeev GANGULA, Wilmington, MA (US); Tommaso MELODIA, Newton, MA (US)

(21) Appl. No.: 19/303,984

(22) Filed: Aug. 19, 2025

Related U.S. Application Data
(60) Provisional application No. 63/684,453, filed on Aug. 19, 2024.

(51) Int. Cl. H04W 56/00; H04J 13/00; H04L 5/00; H04L 25/02; H04L 27/26; H04W 72/231

(52) U.S. Cl. CPC H04W 56/0015; H04J 13/0062; H04L 5/0051; H04L 25/0212; H04L 27/2605; H04W 56/0045; H04W 72/231

(57) ABSTRACT

Provided herein are methods for time synchronization in a telecommunications network comprising receiving, at a user equipment device (UE), from a base station of the telecommunications network, a round trip time downlink control information (DCI) via at least one of a physical downlink control channel or radio resource control messages and a downlink reference signal, synchronizing a downlink timing of the UE according to the downlink reference signal, generating, at the UE, a base uplink reference signal (URS) sequence, converting a current timing advance (TA) of the UE to a corresponding cyclic shift, shifting the base URS sequence according to the cyclic shift, and transmitting the shifted URS sequence to the base station.

### CROSS REFERENCE TO RELATED APPLICATIONS

This application claims benefit under 35 U.S.C. § 119(e) of U.S. Provisional Application No. 63/684,453, filed on 19 Aug. 2024, entitled “System and Method for Round Trip Time Measurement in a Telecommunications Network,” the entirety of which is incorporated by reference herein.

### STATEMENT REGARDING FEDERALLY SPONSORED RESEARCH OR DEVELOPMENT

This invention was made with government support under Grant Number. W911NF-24-2-0065 awarded by the U.S. Army Research Laboratory. The government has certain rights in the invention.

### BACKGROUND

Multi-cell round trip time (multi-RTT) positioning is a well-known positioning technique in 5G standards and is expected to be a part of 6G technology. Current RTT methods suffer from overhead and latency issues due to the timing measurement reporting from the user equipment (UE) to a central entity. The multi-RTT positioning method involves estimating a UE's location using the RTT between the UE and multiple base stations (e.g., gNBs in 5G networks). The distance between the UE and base station is calculated as d=0.5×c×RTT, where c is the speed of light. The trilateration procedure requires RTT measurements from at least three well-placed base stations, as illustrated in FIG. 1.

### 5G Synchronization

In 5G New Radio (5G NR), the synchronization process consists of downlink (DL) and uplink (UL) synchronization. The DL synchronization is achieved by UE acquiring the frame and symbol boundary by decoding the synchronization signal block (SSB) transmitted by the base station. UE is then able to decode the master information block (MIB) from the physical broadcast channel (PBCH) and system information block (SIB) from the physical downlink shared channel (PDSCH). The parameters extracted from the MIB and SIB are necessary to perform UL synchronization.

The gNB handles multiple UEs situated at different distances across the cell. Therefore, each UE's UL transmission time needs to be adjusted to align with the gNB's UL reception. UL synchronization is achieved through a combination of the random access (RA) procedure and timing advance loops. The RA procedure is used during initial access or when the UE loses UL synchronization while timing advance loops continuously adjust the UE's UL time while in a connected state.

The UL synchronization procedure includes a first step wherein the UE selects a preamble from a set of predefined preambles (for contention-based synchronization) or uses a preamble configured by the gNB (for contention-free synchronization) and transmits it over the physical random access channel (PRACH). Upon detecting a preamble, the gNB can measure a coarse RTT. A quantized version of the RTT, known as timing advance (TA), is then sent to the UE via the random access response (RAR). Upon successful reception of RAR, the UE advances its UL timing by the TA. Although the initial TA is sent via the RAR, the gNB can periodically send updated UL timing corrections to the UE via TA commands. These TA commands allow the gNB to maintain UL synchronization in the event of UE mobility or clock drift. This DL and UL synchronization process is illustrated in FIGS. 2-4.

### Reference Signals

Several reference signals are used for channel estimation and positioning in 5G NR. Positioning methods such as downlink time difference of arrival (DL-TDoA), and uplink time difference of arrival (UL-TDoA), downlink angle of departure (DL-AoD) and uplink angle of arrival (UL-AoA), multi-RTT in 5G NR rely on Sounding reference signals (SRS) and positioning reference signals (PRS) [1]. These reference signals were introduced in 4G and extended to 5G with better resolution and accuracy [2]. While the UE transmits the SRS in the UL, PRS is used in the DL. Although SRS for positioning and communication have many commonalities, they can be configured separately [1]. SRS is generated using the Zadoff-Chu sequence, and PRS is generated using quadrature phase shift keying (QPSK) modulated 31-length gold sequence [2].

### Zadoff-Chu Sequences

Zadoff-Chu (ZC) sequences are widely used in 5G NR due to a number of desirable properties. They are used in DL and UL synchronization, channel estimation and in physical uplink control channel (PUCCH).

A ZC sequence of length N_{ZC}, which must be an odd number, and root q∈[1, 2, . . . , N_{ZC}−1] is defined as

$${x}_{q} [ n ] = exp ( - j \frac{π qn ( n + 1 )}{{N}_{ZC}} ) , 0 \leq n \leq {N}_{ZC} - 1 \qquad ( 1 )$$

ZC sequences have several characteristic properties. For example, all of the elements in a ZC sequence have a unit amplitude. Furthermore, ZC sequences exhibit normalized cyclic auto-correlation. That is, when the root q is relatively prime to N_{ZC},

$$\frac{1}{{N}_{ZC}} {\sum }_{n = 0}^{{N}_{ZC} - 1} {x}_{q} [ n ] {x}_{q}^{*} [ ( n + v ) mod {N}_{ZC} ] = δ [ v ] \qquad ( 2 )$$

where mod represents the modulo operation and δ[v] represents the Kronecker delta function. There are N_{ZC} unique cyclic shifts of the sequence x_{q}[n]. ZC sequences also exhibit normalized cyclic cross-correlation: when |q₁−q₂| and N_{ZC} are relatively prime,

$$\frac{1}{{N}_{ZC}} {\sum }_{n = 0}^{{N}_{ZC} - 1} {x}_{{q}_{1}} [ n ] {x}_{{q}_{2}}^{*} [ ( n + v ) mod {N}_{ZC} ] = \frac{1}{\sqrt{{N}_{ZC}}} \qquad ( 3 )$$

Additionally, the DFT or IDFT of a ZC sequence is also a ZC sequence.

### Previous Approaches for Obtaining RTT

There are mainly two existing approaches for obtaining RTT in the cellular network standards defined by the third generation partnership project (3GPP). Scheme A, illustrated in FIG. 4, obtains RTT at the gNB upon receiving a random access channel (RACH) preamble during the random access (RA) procedure described above.

Scheme B, illustrated in FIG. 5, uses wideband reference signals such as sounding reference signals (SRS), positioning reference signals (PRS), Cell Specific Reference Signals (CRS) etc. so that the UE and gNB can estimate a receive-transmit (Rx-Tx) timing difference measurement. In such schemes, the RTT is calculated as

RTT=(UE Rx−Tx time difference+gNB Rx−Tx time difference).

The Enhanced Cell ID (ECID) type I scheme in 4G [3], [4] and multi-RTT scheme in 5G NR [5], [6] follow Scheme B. In 5G NR, SRS and PRS are used in calculating the Rx-Tx time difference measurements at the gNB and UE. The details of time difference measurement report mapping are provided in [7].

Recently, as shown in FIG. 6, another RTT estimation scheme, Scheme C, has been described [8], [9]. Scheme C estimates RTT by combining the TA measurement obtained from RACH with wideband UL channel measurements such as from SRS. This method considerably improves the RTT estimation performance compared to Scheme A while not incurring extra UE Rx-Tx time difference measurement reporting costs as in Scheme B. In Scheme C the gNB first configures the SRS resources and prepares a downlink control information (DCI) and then sends the DCI through the physical downlink control channel (PDCCH). Upon receiving DCI, the UE will correct its DL timing based on either a synchronization signal block (SSB) or a dedicated reference signal such as PRS (if configured). Then the UE will start a contention free random access (RA) procedure using the preamble sent in the DCI. The gNB will decode the RACH received from the UE and send a random access response (RAR). Upon successfully receiving RAR, the UE will adjust its UL transmission timing by applying the timing advance (TA) and send the SRS in the immediately available UL slot, based on the configuration. The gNB will then calculate the RTT based on the delay estimated from RACH and SRS channel impulse response (CIR), RTT is calculated at the gNB.

However, each of the existing RTT schemes (Scheme A, Scheme B, and Scheme C) suffer from significant shortcomings, underscoring the pressing need for improvement in this area. For example, in Scheme A, the RTT accuracy is limited by the low bandwidth of the RACH. Furthermore, the UE performs the RA procedure only during the initial access or when the UL synchronization is lost, creating intermittent connectivity and/or outdated RTT values. Conversely, Scheme B's RTT estimation is more accurate than Scheme A's, because of the wideband reference signals such as SRS and PRS. However, this performance comes at the expense of increased latency and resource consumption, particularly because the UE must send its Rx-Tx time difference measurements to the location management entity. Finally, although it avoids the extra UE Rx-Tx time difference measurement reporting costs associated with Scheme B, the Scheme C approach requires a contention-free RA procedure to estimate the RTT, resulting in additional radio resource consumption and increased latency.

### SUMMARY

Various aspects described herein generally relate to wireless communication systems, specifically to RTT based UE positioning in wireless networks, e.g. in 5G or 6G systems.

As noted above, current RTT methods suffer from poor accuracy, intermittent connectivity, latency, high resource overhead, or combinations thereof due to shortcomings in current schemes for RTT measurement. One source of such issues is timing measurement reporting from UE to a central entity such as a base station. Alternatively or in addition, some existing schemes require the execution of additional RA procedures. The present technology circumvents these measurement reports and RA procedures by applying timing measurement as a cyclic shift while generating a Zadoff-Chu (ZC) sequence-based uplink reference signal (URS).

In one aspect, a method for time synchronization in a telecommunications network is provided. The method includes receiving, at a user equipment device (UE), from a base station of the telecommunications network, a round trip time downlink control information (DCI) via at least one of a physical downlink control channel or radio resource control messages. The method also includes receiving, at a user equipment device (UE), from a base station of the telecommunications network, and a downlink reference signal. The method also includes synchronizing a downlink timing of the UE according to the downlink reference signal. The method also includes generating, at the UE, a base uplink reference signal (URS) sequence. The method also includes converting a current timing advance (TA) of the UE to a corresponding cyclic shift. The method also includes shifting the base URS sequence according to the cyclic shift. The method also includes transmitting the shifted URS sequence to the base station.

In some embodiments, the base URS sequence is a Zadoff-Chu sequence having length N_{ZC} wherein a root q∈[1, 2, . . . , N_{ZC}−1] relative prime to N_{ZC} is defined as

$${x}_{q} [ n ] = exp ( - j \frac{π qn ( n + 1 )}{{N}_{ZC}} ) ,$$

0≤n≤N_{ZC}−1] relative prime to N_{ZC} is defined as sequence is denoted as x_{q,v}[n]=x_{q}[(n−v)modN_{ZC}], wherein v is the cyclic shift. In some embodiments, for cyclic shifts satisfying 0≤TA<N_{ZC}, v=TA and the shifted URS sequence is denoted as x_{q}[(n−TA)modN_{ZC}]. In some embodiments, for cyclic shifts where 0≤TA<BN_{ZC}, the DCI configures the UE with B base URS sequences, each of the B base URS sequences having a different root q. In some embodiments, 0≤TA<2N_{ZC} and for cyclic shifts satisfying 0≤TA<N_{ZC}, v=TA and the shifted URS is denoted as x_{q1}[(n−TA)modN_{ZC}]. In some embodiments, 0≤TA<2N_{ZC} and for cyclic shifts satisfying N_{ZC}≤TA<2N_{ZC}, v=TA−N_{ZC} and the shifted URS is denoted as x_{q2}[n−(TA−N_{ZC})modN_{ZC}]. In some embodiments, the method also includes receiving, at the base station, the shifted URS sequence transmitted by the UE. In some embodiments, the method also includes estimating a delay of the received shifted URS sequence on a measured channel impulse response first peak of the received shifted URS sequence. In some embodiments, the method also includes determining, from the delay, a round trip time between the base station and the UE. In some embodiments, the method also includes receiving, at the base station, a plurality of shifted URS sequences, each received from a corresponding one of a plurality of UE devices, wherein each of the shifted URS sequences maps to one or more subcarriers of an OFDM symbol, the one or more subcarriers of each shifted URS sequence corresponding to a particular one of the plurality of UE devices. In some embodiments, the method also includes estimating a plurality of delays, each corresponding to one of the plurality of shifted URS sequences, based on the measured channel impulse response first peak of each of the plurality of shifted URS sequences. In some embodiments, the method also includes determining, from each of the plurality of delays, a round trip time between the base station and a corresponding one of the plurality of UEs. In some embodiments, the downlink reference signal is one or more of a synchronization signal block, a positioning reference signal, or a cell-specific reference signal. In some embodiments, the downlink reference signal is a synchronization signal block.

In another aspect, a method for time synchronization in a telecommunications network is provided. The method includes receiving, at a user equipment device (UE), from a base station of the telecommunications network, a round trip time downlink control information (DCI) via at least one of a physical downlink control channel or radio resource control messages. The method also includes receiving, at a user equipment device (UE), from a base station of the telecommunications network, a downlink reference signal. The method also includes generating, at the UE, using a Zadoff-Chu sequence, a base uplink reference signal (URS) sequence. The method also includes converting a current timing advance (TA) of the UE to a corresponding TA cyclic shift. The method also includes measuring a downlink channel impulse response first peak, over p samples, of the downlink reference signal, the p samples corresponding to a p cyclic shift. The method also includes shifting the base URS sequence according to a combined cyclic shift including TA and p. The method also includes transmitting the shifted URS sequence to the base station.

In some embodiments, the downlink reference signal is one or more of a SSB, a positioning reference signal, or a cell-specific reference signal. In some embodiments, the downlink reference signal is a positioning reference signal. In some embodiments, the base URS sequence comprises a base sequence having length N_{ZC} wherein a root q∈[1, 2, . . . , N_{ZC}−1] relative prime to N_{ZC} is defined as

$${x}_{q} [ n ] = exp ( - j \frac{π qn ( n + 1 )}{{N}_{ZC}} ) ,$$

0≤n≤N_{ZC}−1. In some embodiments, the cyclic shift is denoted as x_{q,v}[n]=x_{q}[(n−v)modN_{ZC}], wherein v is the combined cyclic shift. In some embodiments, for cyclic shifts satisfying 0≤TA+p<N_{ZC}, v=TA+p and the shifted URS sequence is denoted as x_{q}[(n−TA−p)modN_{ZC}]. In some embodiments, for cyclic shifts where 0≤TA<BN_{ZC}, the DCI configures the UE with B base URS sequences, each of the B base URS sequences having a different root q. In some embodiments, 0≤TA<2N_{ZC} and for cyclic shifts satisfying 0≤TA<N_{ZC}, v=TA+p, and the shifted URS sequence is denoted as x_{q1}[(n−TA−p)modN_{ZC}]. In some embodiments, 0≤TA<2N_{ZC} and for cyclic shifts satisfying N_{ZC}≤TA<2N_{ZC}, v=TA−p−N_{ZC} and the shifted URS sequence is denoted as x_{q2}[n−(TA−p−N_{ZC})modN_{ZC}]. In some embodiments, the method also includes receiving, at the base station, the shifted URS sequence transmitted by the base station. In some embodiments, the method also includes estimating a delay of the received shifted Base URS sequence on a measured channel impulse response first peak of the received shifted URS sequence. In some embodiments, the method also includes determining, from the delay, a round trip time between the base station and the UE. In some embodiments, the method also includes receiving, at the base station, a plurality of shifted URS sequences, each received from a corresponding one of a plurality of UE devices, wherein each of the shifted URS sequences maps to one or more subcarriers of an OFDM symbol, the one or more subcarriers of each shifted URS sequence corresponding to a particular one of the plurality of UE devices. In some embodiments, the method also includes estimating a plurality of delays, each corresponding to one of the plurality of shifted URS sequences, based on the measured channel impulse response first peak of each of the plurality of shifted URS sequences. In some embodiments, the method also includes determining, from each of the plurality of delays, a round trip time between the base station and a corresponding one of the plurality of UEs.

### Additional Features and Aspects of the Technology Include the Following:

1. A method for time synchronization in a telecommunications network comprising:
   receiving, at a user equipment device (UE), from a base station of the telecommunications network:
      a round trip time downlink control information (DCI) via at least one of a physical downlink control channel or radio resource control messages; and
      a downlink reference signal;
   synchronizing a downlink timing of the UE according to the downlink reference signal;
   generating, at the UE, a base uplink reference signal (URS) sequence;
   converting a current timing advance (TA) of the UE to a corresponding cyclic shift;
   shifting the base URS sequence according to the cyclic shift; and
   transmitting the shifted URS sequence to the base station.
2. The method of feature 1, wherein the base URS sequence is a Zadoff-Chu sequence having length N_{ZC} wherein a root q∈[1, 2, . . . , N_{ZC}−1] relative prime to N_{ZC} is defined as

$${x}_{q} [ n ] = exp ( - j \frac{π qn ( n + 1 )}{{N}_{ZC}} ) ,$$

0≤n≤N_{ZC}−1.
3. The method of feature 2, wherein the shifted URS sequence is denoted as x_{q,v}[n]=x_{q}[(n−v)modN_{ZC}], wherein v is the cyclic shift.
4. The method of feature 3, wherein for cyclic shifts satisfying 0≤TA<N_{ZC},v=TA and the shifted URS sequence is denoted as x_{q}[(n−TA)modN_{ZC}].
5. The method of feature 3, wherein, for cyclic shifts where 0≤TA<BN_{ZC}, the DCI configures the UE with B base URS sequences, each of the B base URS sequences having a different root q.
6. The method of feature 5, wherein 0≤TA<2N_{ZC} and wherein:
   for cyclic shifts satisfying 0≤TA<N_{ZC}, v=TA and the shifted URS is denoted as x_{q1}[(n−TA)modN_{ZC}]; and
   for cyclic shifts satisfying N_{ZC}≤TA<2N_{ZC}, v=TA−N_{ZC} and the shifted URS is denoted as x_{q2}[n−(TA−N_{ZC})modN_{ZC}].
7. The method of features 1-6, further comprising:
   receiving, at the base station, the shifted URS sequence transmitted by the UE;
   estimating a delay of the received shifted URS sequence on a measured channel impulse response first peak of the received shifted URS sequence; and
   determining, from the delay, a round trip time between the base station and the UE.
8. The method of any of features 1-7, further comprising:
   receiving, at the base station, a plurality of shifted URS sequences, each received from a corresponding one of a plurality of UE devices, wherein each of the shifted URS sequences maps to one or more subcarriers of an OFDM symbol, the one or more subcarriers of each shifted URS sequence corresponding to a particular one of the plurality of UE devices;
   estimating a plurality of delays, each corresponding to one of the plurality of shifted URS sequences, based on the measured channel impulse response first peak of each of the plurality of shifted URS sequences; and
   determining, from each of the plurality of delays, a round trip time between the base station and a corresponding one of the plurality of UEs.
9. The method of any of features 1-8, wherein the downlink reference signal is one or more of a synchronization signal block, a positioning reference signal, or a cell-specific reference signal.
10. The method of feature 9, wherein the downlink reference signal is a synchronization signal block.
11. A method for time synchronization in a telecommunications network comprising:
   receiving, at a user equipment device (UE), from a base station of the telecommunications network:
      a round trip time downlink control information (DCI) via at least one of a physical downlink control channel or radio resource control messages; and
      a downlink reference signal;
   generating, at the UE, using a Zadoff-Chu sequence, a base uplink reference signal (URS) sequence;
   converting a current timing advance (TA) of the UE to a corresponding TA cyclic shift;
   measuring a downlink channel impulse response first peak, over p samples, of the downlink reference signal, the p samples corresponding to a p cyclic shift;
   shifting the base URS sequence according to a combined cyclic shift including TA and p; and
   transmitting the shifted URS sequence to the base station.
12. The method of feature 11, wherein the downlink reference signal is one or more of a SSB, a positioning reference signal, or a cell-specific reference signal.
13. The method of feature 12, wherein the downlink reference signal is a positioning reference signal.
14. The method of any of features 11-13, wherein the base URS sequence comprises a base sequence having length N_{ZC} wherein a root q∈[1, 2, . . . , N_{ZC}−1] relative prime to N_{ZC} is defined as 0≤n≤N_{ZC}−1.

$${x}_{q} [ n ] = exp ( - j \frac{π qn ( n + 1 )}{{N}_{ZC}} ) ,$$

0≤n≤N_{ZC}−1.
15. The method of feature 14, wherein the cyclic shift is denoted as x_{q,v}[n]=x_{q}[(n−v)modN_{ZC}], wherein v is the combined cyclic shift.
16. The method of feature 15, wherein for cyclic shifts satisfying 0≤TA+p<N_{ZC}, v=TA+p and the shifted URS sequence is denoted as x_{q}[(n−TA−p)modN_{ZC}].
17. The method of feature 15, wherein, for cyclic shifts where 0≤TA<BN_{ZC}, the DCI configures the UE with B base URS sequences, each of the B base URS sequences having a different root q.
18. The method of feature 17, wherein 0≤TA<2N_{ZC} and wherein:
   for cyclic shifts satisfying 0≤TA<N_{ZC}, v=TA+p, and the shifted URS sequence is denoted as x_{q1}[(n−TA−p)modN_{ZC}]; and
   for cyclic shifts satisfying N_{ZC}≤TA<2N_{ZC}, v=TA−p−N_{ZC} and the shifted URS sequence is denoted as x_{q2}[n−(TA−p−N_{ZC})modN_{ZC}].
19. The method of any of features 11-18, further comprising:
   receiving, at the base station, the shifted URS sequence transmitted by the base station;
   estimating a delay of the received shifted Base URS sequence on a measured channel impulse response first peak of the received shifted URS sequence; and
   determining, from the delay, a round trip time between the base station and the UE.
20. The method of any of features 11-19, further comprising:
   receiving, at the base station, a plurality of shifted URS sequences, each received from a corresponding one of a plurality of UE devices, wherein each of the shifted URS sequences maps to one or more subcarriers of an OFDM symbol, the one or more subcarriers of each shifted URS sequence corresponding to a particular one of the plurality of UE devices;
   estimating a plurality of delays, each corresponding to one of the plurality of shifted URS sequences, based on the measured channel impulse response first peak of each of the plurality of shifted URS sequences; and
   determining, from each of the plurality of delays, a round trip time between the base station and a corresponding one of the plurality of UEs.

A list of acronyms and variables referenced in this disclosure and their respective definitions is provided below:

| | |
|---|---|
| 5^{th} Generation | 5G |
| 5G New Radio | 5G NR |
| 6^{th} Generation | 6G |
| Cell Specific Reference Signals | CRS |
| Channel Impulse Response | CIR |
| Downlink Angle of Departure | DL-AoD |
| Downlink Control Information | DCI |
| Downlink Time Difference of Arrival | DL-TDoA |
| Enhanced Cell ID | ECID |
| Master Information Block | MIB |
| Orthogonal Frequency-Division Multiplexing | OFDM |
| Physical Broadcast Channel | PBCH |
| Physical Downlink Shared Channel | PDSCH |
| Physical Random Access Channel | PRACH |
| Physical Uplink Control Channel | PUCCH |
| Positioning Reference Signals | PRS |
| Quadrature Phase Shift Keying | QPSK |
| Radio Resource Control | RRC |
| Random Access | RA |
| Random Access Response | RAR |
| Receive-Transmit Timing Difference | Rx − Tx |
| Round Trip Time | RTT |
| Signal to Noise Ratio | SNR |
| Sounding Reference Signals | SRS |
| Synchronization Signal Block | SSB |
| System Information Block | SIB |
| Third Generation Partnership Project | 3GPP |
| Timing Advance | TA |
| Uplink Angle of Arrival | UL-AoA |
| Uplink Time Difference of Arrival | UL-TDoA |
| User Equipment | UE |
| Wireless Internet of Things | WIoT |
| Zadoff-Chu | ZC |

### BRIEF DESCRIPTION OF THE DRAWINGS

FIG. 1 illustrates trilateration for multi-RTT positioning in accordance with the prior art.

FIG. 2 illustrates initial access signaling in 5G in accordance with the prior art.

FIG. 3 illustrates RTT estimation with RACH in accordance with the prior art.

FIG. 4 illustrates UL timing adjustment at the UE in accordance with the prior art.

FIG. 5 illustrates estimation of RTT in Scheme B in accordance with the prior art.

FIG. 6 illustrates signaling mechanisms in Scheme C in accordance with the prior art.

FIG. 7 illustrates an uplink reference signal (URS) transmission chain at the UE in accordance with various embodiments.

FIG. 8 illustrates an uplink reference signal (URS) receiver chain at the base station (e.g., gNB) in accordance with various embodiments.

FIG. 9 illustrates a downlink timing correction and timing advance (TA) based URS generation signaling scheme in accordance with various embodiments.

FIG. 10 illustrates a downlink delay and TA based URS generation signaling scheme in accordance with various embodiments.

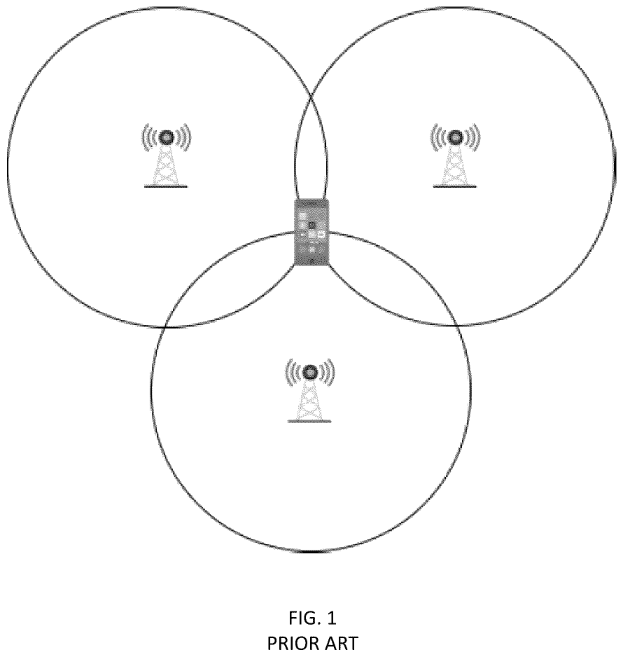

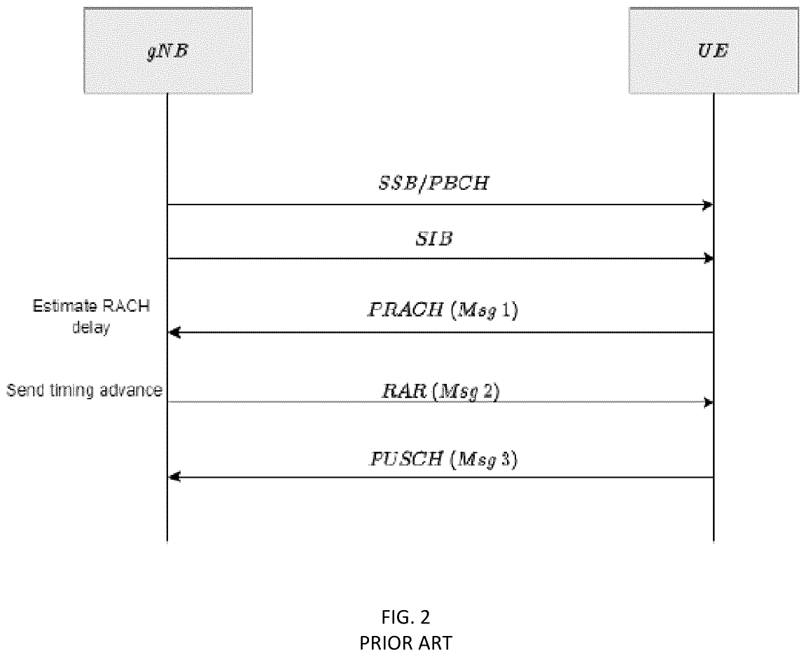

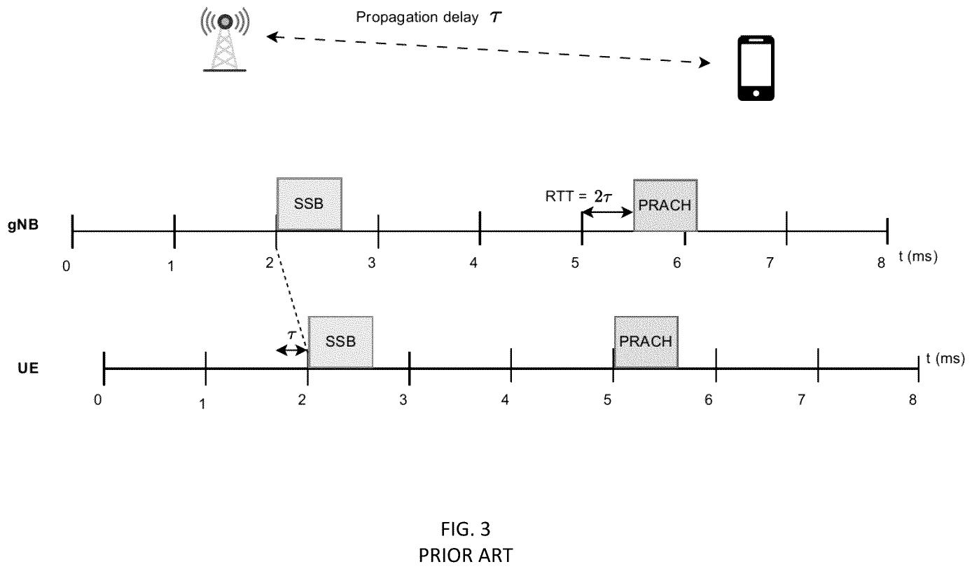

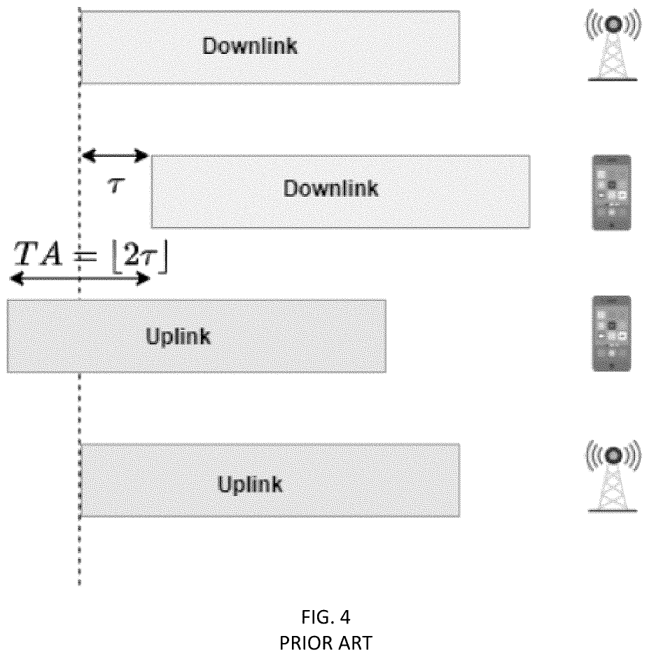

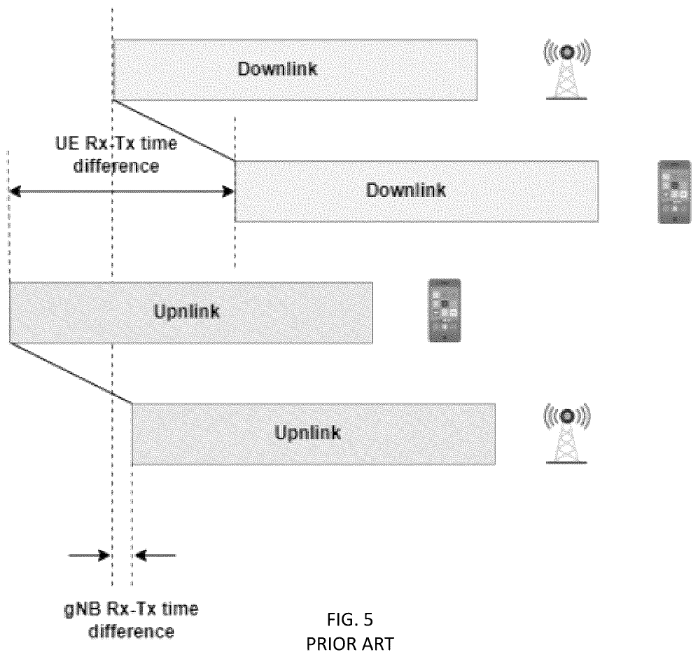

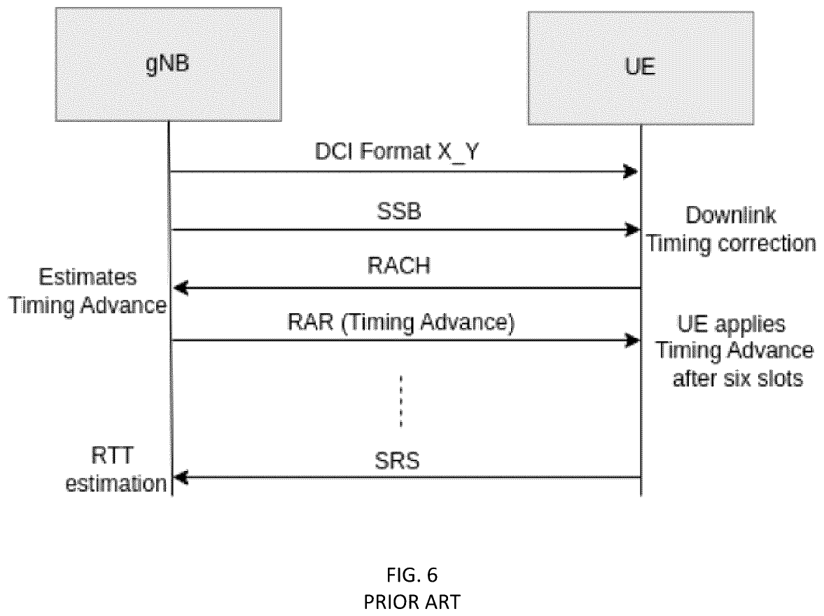

### DETAILED DESCRIPTION

The present technology provides RTT based UE positioning in wireless networks, e.g. in 5G or 6G systems. Current RTT methods suffer from poor accuracy, intermittent connectivity, latency, high resource overhead, or combinations thereof due to shortcomings in current schemes for RTT measurement. One source of such issues is timing measurement reporting from UE to a central entity such as a base station. Alternatively or in addition, some existing schemes require the execution of additional RA procedures. The present technology circumvents these measurement reports and RA procedures by applying timing measurement as a cyclic shift while generating a Zadoff-Chu sequence-based uplink reference signal.

That is, the present technology avoids measurement reporting or an additional RA procedure in state-of-the-art RTT estimation methods. Instead, the present technology uses a current TA, applied at the UE, and/or a delay measured from a downlink wideband reference signal, such as a PRS, as a cyclic shift while generating a Zadoff-Chu sequence-based wideband uplink reference signal. RTT is estimated at the base station based on the peak detected from the CIR. A 3GPP-like signaling is required to perform the method.

Described herein are two schemes employing the present technology. Namely, a downlink timing correction and TA based URS generation scheme and a downlink delay and TA based URS generation scheme. While the downlink timing correction and TA based URS generation scheme enhances Scheme C (see above) by removing the RA procedure, the downlink delay and TA based URS generation scheme enhances Scheme B (see above) by avoiding the need for sending receive-transmit time difference (Rx-Tx time difference) measurements by the user (UE). In both schemes, the central idea is to use the current TA and the delay (in samples) estimated from the downlink reference signals (example from PRS) at the UE as a cyclic shift while generating an uplink wideband reference signal. The generation and reception of the proposed uplink reference signal (URS) followed by the RTT estimation is presented below.

### Uplink Reference Signal

The URS is generated first by determining a URS base sequence from a ZC sequence consistent with the ZC sequences described more broadly above. In particular, the URS base sequence has a length N_{ZC} and the root q∈[1, 2, . . . , N_{ZC}−1] relative prime to N_{ZC} is defined according to Eq. (1) as

$${x}_{q} [ n ] = exp ( - j \frac{π qn ( n + 1 )}{{N}_{ZC}} ) ,$$

0≤n≤N_{ZC}−1.

The cyclic shifted URS sequence can thus be denoted by

x_{q,v}[n]=x_{q}[(n−v)modN_{ZC}] (4)

where v is the cyclic shift. It is important to note two properties of the shifted sequence which facilitate RTT estimation according to the schemes described herein. These properties can be defined according to

$${x}_{q} [ n ] {\to }^{ℱ} {X}_{q} [ k ] \qquad ( 5 )$$

$${x}_{q} [ ( n - v ) mod {N}_{ZC} ] {\to }^{ℱ} {X}_{q} [ k ] exp ( - j \frac{2 π kv}{{N}_{ZC}} ) \qquad ( 6 )$$

where [symbol] denotes the Fourier Transform (FFT) operation and 0≤k≤N_{ZC}−1. There are N_{ZC} unique cyclic shifts.

### Transmit and Receive Chain

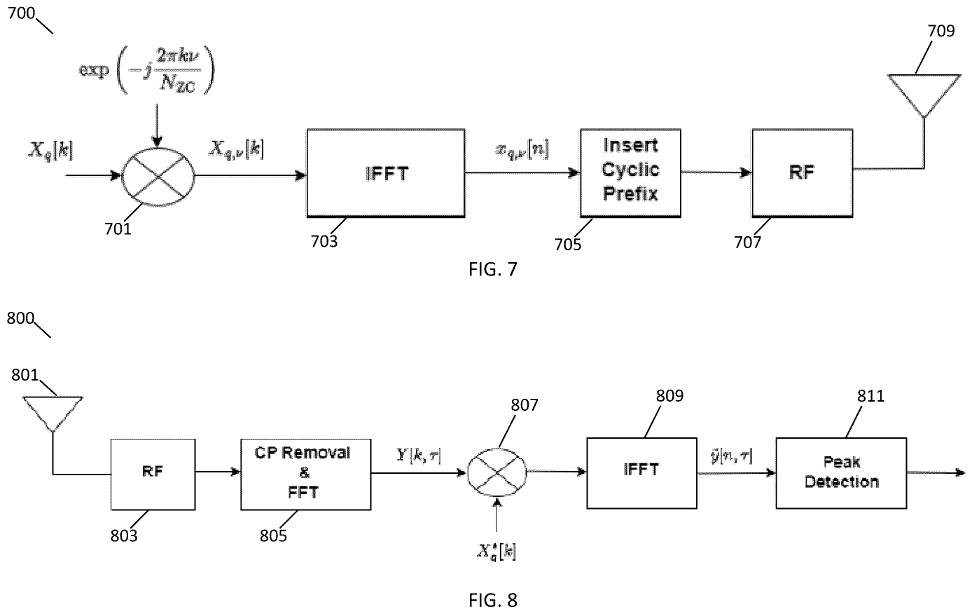

The transmitter block 700 for URS transmission at the UE for the present technology in an orthogonal frequency-division multiplexing (OFDM) based system, such as 5G NR, is shown in FIG. 7. The UE generated URS is given by x_{q,v}[n].

The received time domain baseband signal at the base station can be written as

y[n,τ]=x_{q,v}[n] [symbol] h[n−τ]+w[n],0≤n≤N_{ZC}−1 (7)

where h[⋅] denotes the wireless channel inducing a propagation delay τ, [symbol] denotes the circular convolution, and w[⋅] is the additive white Gaussian noise.

The receiver block 800 for receiving the URS at the base station is shown in FIG. 8. After removing the cyclic prefix and performing the FFT

$$Y [ k , τ ] = {X}_{q , v} [ k ] H [ k ] {e}^{- j \frac{2 π k τ}{{N}_{ZC}}} + W [ k ] , 0 \leq k \leq {N}_{ZC} - 1 \qquad ( 8 )$$

By correlating with the base reference signal sequence,

$$Y [ k , τ ] {X}_{q}^{*} [ k ] = H [ k ] {e}^{- j \frac{2 π k τ}{{N}_{ZC}}} {X}_{q , v} [ k ] {X}_{q}^{*} [ k ] + \tilde{W} [ k ] = H [ k ] {e}^{- j \frac{2 π k ( τ + v )}{{N}_{ZC}}} + \tilde{W} [ k ] \qquad ( 9 )$$

After performing inverse FFT (IFFT)

$$\tilde{y} [ n , τ ] = {ℱ}^{- 1} \{ Y \vert k , τ \vert {X}_{q}^{*} [ k ] \} = h [ n - ( τ + v ) ] + \tilde{w} [ n ] \qquad ( 10 )$$

where the peak of |\tilde{y}[n,τ]| at τ+v corresponds to the cyclic shift v and propagation delay τ.

### Downlink Timing Correction and TA Based URS Generation Scheme

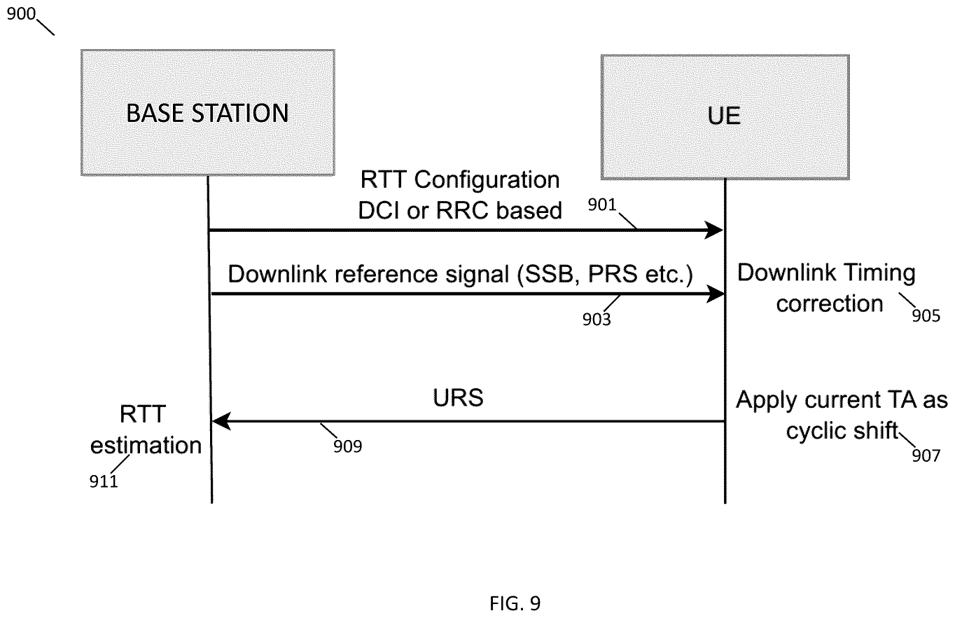

The downlink timing correction and TA based URS generation signaling scheme 900, shown in FIG. 9, can include configuring the URS resources at the base station and preparing the UE by sending RTT DCI 901 through a PDCCH similar to [9] or by RRC messages similar to [5]. The UE initially corrects its DL frame timing 905 according to a downlink reference signal such as, for example, a SSB 903 or a dedicated reference signal (if configured) (e.g., a PRS or a CRS). Then, the UE converts a current TA (e.g., the TA as most recently updated via a timing advance command received from the base station) into a cyclic shift and applies the cyclic shift TA 907 to the base URS sequence x_{q}[n], resulting in x_{q}[(n−TA)modN_{ZC}]. Once the cyclic shift has been applied, the UE transmits the URS 909. The base station then receives the transmitted URS 909 and estimates propagation delay 911 from channel impulse response first peak at the base station to determine the RTT=2τ.

It is noted that this downlink timing correction and TA based URS generation scheme only works when the cyclic shift satisfies the constraint 0≤TA<N_{ZC}. Techniques for use in circumstances where TA>N_{ZC} are described below. It is also noted that, for a well calibrated UE, TA is always a non-negative quantity.

### Downlink Delay and TA Based URS Generation Scheme

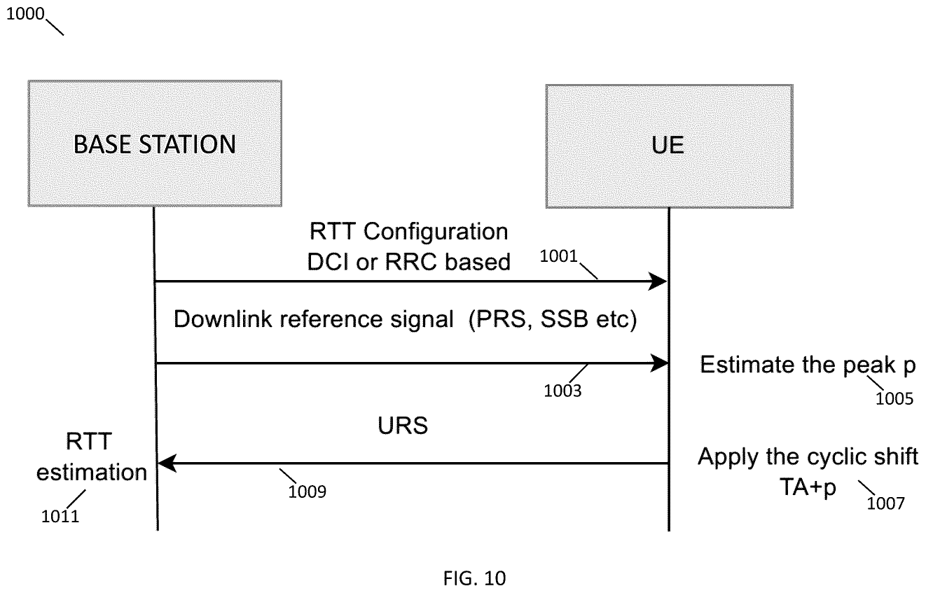

The downlink delay and TA based URS generation signaling scheme 1000, shown in FIG. 10, can include configuring the URS and downlink reference signal (e.g., PRS as shown) resources at the base station and preparing the UE by sending RTT downlink control information (DCI) 1001 through a PDCCH similar to [9] or by RRC messages similar to [5]. The UE initially measures a CIR first peak, p samples, 1005 of the downlink reference signal (e.g., a PRS or a CRS) 1003 received from the base station. Then, the UE converts a current TA (e.g., the TA as most recently updated via a timing advance command received from the base station) into a cyclic shift, and applies a total cyclic shift of TA+p 1007 to the base URS sequence x_{q}[n], resulting in x_{q}[(n−TA−p)modN_{ZC}]. Once the cyclic shift has been applied, the UE transmits the URS 1009. The base station then receives the transmitted URS 1009 and estimates propagation delay 1011 from channel impulse response first peak at the base station to determine the RTT=2τ.

It is noted that this downlink delay and TA based URS generation scheme only works when the cyclic shift satisfies the constraint 0≤TA+p<N_{ZC}. Techniques for use in circumstances where TA+p>N_{ZC} are described below.

### Larger Timing Advances

For large TA values exceeding N_{ZC}, the downlink timing correction and TA scheme 900 and downlink delay and TA scheme 1000 can be extended by using multiple base URS sequences having different roots for each multiple of N_{ZC}. In other words, where 0≤TA<BN_{ZC}, the downlink timing correction and TA scheme 900 and downlink delay and TA scheme 1000 can be implemented by configuration of the UE with B URS base sequences.

For example, a scenario where 0≤TA<2N_{ZC} can be implemented for the downlink timing correction and TA based URS generation scheme as follows. Initially, the base station can configure the UE with two URS base sequences x_{q1}[n] and x_{q2}[n]. The URS generation at UE would be constrained such that if 0≤TA<N_{ZC}, the UE will generate the URS according to x_{q1}[(n−TA)modN_{ZC}] and, if N_{ZC}≤TA<2N_{ZC}, the UE will generate the URS according to x_{q2}[(n−(TA−Nz_{c}))modN_{ZC}].

In such implementations, the roots, q∈[1, 2, . . . , N_{ZC}−1], are selected such that q₁, q₂, and |q₁−q₂| are relative prime with N_{ZC}. The base station can detect the delay and the root index using the auto-correlation and cross-correlation properties stated in (2) and (3). If the peak, \hat{p}, is detected at the base station, then by correlation of the received signal, the base station can detect which base sequence is applicable and, if the base sequence is x_{q1}[n], then RTT=\hat{p} and, if the base sequence is x_{q2}[n], then RTT=N_{ZC}+\hat{p}. This example is also extendable to TAs falling between zero to any number of multiples of N_{ZC}.

### Multiple User Environments

In some embodiments, wherein the base station is in communication with multiple UEs, a plurality of UEs can be multiplexed into a single OFDM symbol using a comb structure in the frequency domain. The structure is similar to the structure used for SRS [2] but, in this instance, would be modified to facilitate RTT estimation for multiple UEs using the same OFDM symbol.

In practice, the base station would receive a plurality of shifted URSs, each received from a corresponding one of the plurality of UE devices. Each of the shifted URSs would be received on one or more subcarriers of an OFDM symbol, wherein the one or more subcarriers of each shifted URS correspond to a particular one of the plurality of UE devices. The base station is then able to estimate a plurality of delays, based on the measured channel impulse response first peak of each of the plurality of shifted URSs. Each delay corresponds to a particular one of the plurality of shifted URSs and thus also corresponds to a particular one of the UEs. The base station can then determine a RTT between the base station and each of the plurality of UEs.

For example, in an embodiment where two UEs (UE1 and UE2) are communicating with a base station and the base station is communicating using an OFDM symbol having 100 subcarriers, UE1 can be assigned to use (mapped to) even subcarriers, and UE2 can be assigned to use (mapped to) odd subcarriers. Thus, the base station can estimate the delay for each UE based on the first peak of channel impulse response from the URS sent by that UE. That is, the first peak of channel impulse response for a URS using even subcarriers will correspond to UE1 and the first peak of channel impulse response for a URS using odd subcarriers will correspond to UE2.

Due to its simplicity and savings in radio resources in comparison to existing multi-RTT methods in the 3GPP standards, the present technology can be used in upcoming 3GPP releases and in the Wireless Internet of Things (WIoT). However, any wireless communication system performing RTT-based positioning could benefit from the present technology. For example, some advantages of the present technology include the following: (1) the present technology achieves a substantial reduction in radio resource consumption when compared to state-of-art RTT measurement methods used in connection with 5G 3GPP standards; (2) the present technology reduces latency associated with estimating RTT when compared to present state-of-art methods in 5G; and (3) unlike present state-of-art methods, the present technology performs well even in low signal to noise ratio (SNR) conditions.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

### REFERENCES

[1]S. Dwivedi et al., “Positioning in 5G networks,” IEEE Communications Magazine, vol. 59, no. 11, pp. 38-44, 2021.
[2]3GPP, “NR; physical channels and modulation,” 3rd Generation Partnership Project (3GPP), Technical Specification (TS) 38.2]]v]6.0.0, 2020.
[3] -, “Evolved Universal Terrestrial Radio Access (E-UTRA); LTE Positioning Protocol (LPP),” 3rd Generation Partnership Project (3GPP), Technical Specification (TS) 36.355 V9.]0.0, 2013.
[4] -, “Evolved Universal Terrestrial Radio Access Network (E-UTRAN); Stage 2 functional specification of User Equipment (UE) positioning in E-UTRAN,” 3rd Generation Partnership Project (3GPP), Technical Specification (TS) 36.305 V9.]0.0, 2013.
[5] -, “NG Radio Access Network (NG-RAN); Stage 2 functional specification of User Equipment (UE) positioning in NG-RAN,” 3rd Generation Partnership Project (3GPP), Technical Specification (TS) 38.305 V]7.0.0, 2022.
[6] -, “LTE Positioning Protocol (LPP),” 3rd Generation Partnership Project (3GPP), Technical Specification (TS) 37.355 V]7.0.0, 2022.
[7] -, “NR; Requirements for support of radio resource management,” 3rd Generation Partnership Project (3GPP), Technical Specification (TS) 38.]33 V]7.5.0, 2022-05.
[8]R. Mundlamuri, R. Gangula, F. Kaltenberger, and R. Knopp, “Novel round trip time estimation in 5G NR,” arXiv preprint, 2024. [Online]. Available: arxiv.org/abs/2404.19618v1.
[9]R. Mundlamuri, R. Gangula, O. Esrafilian, F. Kaltenberger, R. Knopp, D. Gesbert, S. Wagner, and K. L. Trung, “System and a method for improved round trip time estimation,” in European Patent Application 23306847.7.

What is claimed is:

1. A method for time synchronization in a telecommunications network comprising:
receiving, at a user equipment device (UE), from a base station of the telecommunications network:
a round trip time downlink control information (DCI) via at least one of a physical downlink control channel or radio resource control messages; and
a downlink reference signal;
synchronizing a downlink timing of the UE according to the downlink reference signal;
generating, at the UE, a base uplink reference signal (URS) sequence;
converting a current timing advance (TA) of the UE to a corresponding cyclic shift;
shifting the base URS sequence according to the cyclic shift; and
transmitting the shifted URS sequence to the base station.

2. The method of claim 1, wherein the base URS sequence is a Zadoff-Chu sequence having length N_{ZC} wherein a root q∈[1, 2, . . . , N_{ZC}−1] relative prime to N_{ZC} is defined as
$${x}_{q} [ n ] = exp ( - j \frac{π qn ( n + 1 )}{{N}_{ZC}} ) ,$$
0≤n≤N_{ZC}−1.

3. The method of claim 2, wherein the shifted URS sequence is denoted as x_{q,v}[n]=x_{q}[(n−v)modN_{ZC}], wherein v is the cyclic shift.

4. The method of claim 3, wherein for cyclic shifts satisfying 0≤TA<N_{ZC}, v=TA and the shifted URS sequence is denoted as x_{q}[(n−TA)modN_{ZC}].

5. The method of claim 3, wherein, for cyclic shifts where 0≤TA<BN_{ZC}, the DCI configures the UE with B base URS sequences, each of the B base URS sequences having a different root q.

6. The method of claim 5, wherein 0≤TA<2N_{ZC} and wherein:
for cyclic shifts satisfying 0≤TA<N_{ZC}, v=TA and the shifted URS is denoted as x_{q1}[(n−TA)modN_{ZC}]; and
for cyclic shifts satisfying N_{ZC}≤TA<2N_{ZC}, v=TA−N_{ZC} and the shifted URS is denoted as x_{q2}[n−(TA−N_{ZC})modN_{ZC}].

7. The method of claim 1, further comprising:
receiving, at the base station, the shifted URS sequence transmitted by the UE;
estimating a delay of the received shifted URS sequence on a measured channel impulse response first peak of the received shifted URS sequence; and
determining, from the delay, a round trip time between the base station and the UE.

8. The method of claim 1, further comprising:
receiving, at the base station, a plurality of shifted URS sequences, each received from a corresponding one of a plurality of UE devices, wherein each of the shifted URS sequences maps to one or more subcarriers of an OFDM symbol, the one or more subcarriers of each shifted URS sequence corresponding to a particular one of the plurality of UE devices;
estimating a plurality of delays, each corresponding to one of the plurality of shifted URS sequences, based on the measured channel impulse response first peak of each of the plurality of shifted URS sequences; and
determining, from each of the plurality of delays, a round trip time between the base station and a corresponding one of the plurality of UEs.

9. The method of claim 1, wherein the downlink reference signal is one or more of a synchronization signal block, a positioning reference signal, or a cell-specific reference signal.

10. The method of claim 9, wherein the downlink reference signal is a synchronization signal block.

11. A method for time synchronization in a telecommunications network comprising:
receiving, at a user equipment device (UE), from a base station of the telecommunications network:
a round trip time downlink control information (DCI) via at least one of a physical downlink control channel or radio resource control messages; and
a downlink reference signal;
generating, at the UE, using a Zadoff-Chu sequence, a base uplink reference signal (URS) sequence;
converting a current timing advance (TA) of the UE to a corresponding TA cyclic shift;
measuring a downlink channel impulse response first peak, over p samples, of the downlink reference signal, the p samples corresponding to a p cyclic shift;
shifting the base URS sequence according to a combined cyclic shift including TA and p; and
transmitting the shifted URS sequence to the base station.

12. The method of claim 11, wherein the downlink reference signal is one or more of a SSB, a positioning reference signal, or a cell-specific reference signal.

13. The method of claim 12, wherein the downlink reference signal is a positioning reference signal.

14. The method of claim 11, wherein the base URS sequence comprises a base sequence having length N_{ZC} wherein a root q∈[1, 2, . . . , N_{ZC}−1] relative prime to N_{ZC} is defined as
$${x}_{q} [ n ] = exp ( - j \frac{π qn ( n + 1 )}{{N}_{ZC}} ) ,$$
0≤n≤N_{ZC}−1.

15. The method of claim 14, wherein the cyclic shift is denoted as x_{q,v}[n]=x_{q}[(n−v)modN_{ZC}], wherein v is the combined cyclic shift.

16. The method of claim 15, wherein for cyclic shifts satisfying 0≤TA+p<N_{ZC}, v=TA+p and the shifted URS sequence is denoted as x_{q}[(n−TA−p)modN_{ZC}].

17. The method of claim 15, wherein, for cyclic shifts where 0≤TA<BN_{ZC}, the DCI configures the UE with B base URS sequences, each of the B base URS sequences having a different root q.

18. The method of claim 17, wherein 0≤TA<2N_{ZC} and wherein:
for cyclic shifts satisfying 0≤TA<N_{ZC}, v=TA+p, and the shifted URS sequence is denoted as x_{q1}[(n−TA−p)modN_{ZC}]; and
for cyclic shifts satisfying N_{ZC}≤TA<²N_{ZC}, v=TA−p−N_{ZC} and the shifted URS sequence is denoted as x_{q2}[n−(TA−p−N_{ZC})modN_{ZC}].

19. The method of claim 11, further comprising:
receiving, at the base station, the shifted URS sequence transmitted by the base station;
estimating a delay of the received shifted Base URS sequence on a measured channel impulse response first peak of the received shifted URS sequence; and
determining, from the delay, a round trip time between the base station and the UE.

20. The method of claim 11, further comprising:
receiving, at the base station, a plurality of shifted URS sequences, each received from a corresponding one of a plurality of UE devices, wherein each of the shifted URS sequences maps to one or more subcarriers of an OFDM symbol, the one or more subcarriers of each shifted URS sequence corresponding to a particular one of the plurality of UE devices;
estimating a plurality of delays, each corresponding to one of the plurality of shifted URS sequences, based on the measured channel impulse response first peak of each of the plurality of shifted URS sequences; and
determining, from each of the plurality of delays, a round trip time between the base station and a corresponding one of the plurality of UEs.
